(19) United States
(12) Patent Application Publication
(10) Pub. No.: US 2004/0162735 A1
(43) Pub. Date: Aug. 19, 2004

(54) System and method for processing multi-part documentation in a networked environment

(75) Inventors: Scott D. Noe, Seattle, WA (US); Anthony McDermott, Dublin (IE); Andre Huy Tran Nguyen, Seattle, WA (US); Neven Stojanovic, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Expeditors International of Washington, Inc.

(21) Appl. No.: 10/368,686

(22) Filed: Feb. 14, 2003

(51) Int. Cl. G06F 17/60

(52) U.S. Cl. 705/1

(57) ABSTRACT

A system and method for integrating multi-part documentation in a networked environment are provided. A port agent processing system obtains incoming shipment information and obtains a declaration identification number corresponding to each shipment from a central document processing system. The port agent processing system generates a short form declaration for the shipment corresponding to the declaration identification number. Thereafter, the central document processing system utilizes the declaration identification number to obtain additional shipment information and generate a supplemental declaration corresponding to the same shipment.

### FIELD OF THE INVENTION

In general, the present invention relates to computer networks and software, and in particular, to a system and method for facilitating integration of documentation processing in a networked environment.

### BACKGROUND OF THE INVENTION

Generally described, transactions, such as international commerce transactions, typically require a number of documents to facilitate the movement of goods related to the transaction. In an example international transaction, international shipments of goods typically require a number of documents/information to allow the goods to be filed with and released by customs officials of an importing country. To the extent any required document is missing, incomplete or incorrect, an international shipment of goods may be prevented from being imported by customs officials until the documentation/information is complete and correct. If the importation of goods is delayed sufficiently, an importer often incurs penalties for storage of the goods at the port of entry. Further, the importer can suffer additional financial losses associated with the unavailability of the goods for sale/manufacture and/or the loss of perishable goods.

In one illustrative embodiment, an importer may initiate shipments of goods from a number of shippers that enter the importing country through a number of ports of entry. From a financial aspect, as the number and frequency of international shipments increase, the financial risk associated with penalties, additional storage costs and/or delayed shipments can also increase significantly. Accordingly, importers are generally motivated to monitor their shipments to ensure that any problems associated with individual shipments, such as inadequate or incorrect documentation/information, are resolved as quickly as possible. Additionally, importers are motivated to monitor shipper performance/compliance to identify problematic shippers.

From a logistical aspect, in a high volume shipment environment encompassing a number of ports of entry, centralized monitoring of documentation is made more difficult by the need for having a local presence at each port of entry to physically manage incoming shipment documentation. Additionally, some government agencies facilitate interaction with local port agents by allowing for a minimum amount of information to be submitted by the port agent before the goods are cleared. Accordingly, the importer may follow up with supplemental information at some time later. To the extent an importer utilizes various third-party document management services to provide the initial information, the problems associated with centralized documentation management increases for importers that utilize a number of third-party document services. This problem is further amplified if the importer utilizes multiple third-party document management services that may have inconsistent data formats or communication architecture.

Thus, there is a need for a system and method for providing centralized shipment documentation processing.

### SUMMARY OF THE INVENTION

A system and method for integrating multi-part documentation in a networked environment are provided. A port agent processing system obtains incoming shipment information and obtains a declaration identifier corresponding to each shipment from a central document processing system. The port agent processing system generates a short form declaration for the shipment corresponding to the declaration identifier. Thereafter, the central document processing system utilizes the declaration identification number to obtain additional shipment information and generate a supplemental declaration corresponding to the same shipment.

In accordance with an aspect of the present invention, a method for processing transaction documentation is provided. The method may be implemented in a system including at least one port agent processing system and a centralized document processing system. In accordance with the method, a computing device obtains incoming shipment information corresponding to a shipment of goods to be imported. The computing device generates a declaration identifier request. The request includes a specification of a subset of the incoming shipment information. The computing device obtains a declaration identifier corresponding to the shipment of goods and generates a declaration document corresponding to the subset of the incoming shipment information and the declaration identifier.

In accordance with another aspect of the present invention, a method for processing transaction documentation is provided. The method may be implemented in a system including at least one port agent component and a centralized document processing component. In accordance with the method a port agent component obtains incoming shipment information corresponding to a shipment of goods to be imported. The port agent component generates a declaration identifier request. The request includes a specification of a subset of the incoming shipment information. A centralized document processing component obtains the declaration identifier request from the port agent component. The centralized document processing component generates a declaration identifier corresponding to the shipment of goods. The port agent component obtains the declaration identifier corresponding to the shipment of goods and generates a first declaration document corresponding to the subset of the incoming shipment information and the declaration identifier. The centralized document processing component generates a second declaration document corresponding to at least a subset of the incoming shipment information and the declaration identifier. The first and second declarations correspond to a complete declaration for the incoming shipment of goods.

In accordance with a further aspect of the present invention, a system for processing transaction documentation is provided. The system includes at least one port agent processing system for obtaining incoming shipment information corresponding to a shipment of goods and for generating a request for a declaration identifier corresponding to the shipment of goods. The system further includes a centralized document processing computing device for processing the request for the declaration identifier from the at least one port agent processing system. The port agent processing system generates a first declaration document corresponding to a subset of the incoming shipment information and the declaration identifier. The centralized document processing system generates a second declaration document corresponding to at least a subset of the incoming shipment information and the declaration identifier. The first and second documents include different subsets of the incoming shipment information.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a document processing system including a number of port agent processing systems and a central document processing system formed in accordance with the present invention;

FIG. 3 is a block diagram depicting an illustrative architecture for a port agent processing system in accordance with the present invention;

FIG. 4 is a block diagram depicting an illustrative architecture for a central document processing system in accordance with the present invention;

FIG. 5 is a block diagram of the document processing system of FIG. 2 illustrating the processing of incoming shipment information and the generation of a declaration identification number in accordance with the present invention;

FIG. 6 is a block diagram of the document processing system of FIG. 2 illustrating the generation of a short form declaration and a supplemental declaration from a declaration identification number in accordance with the present invention;

FIG. 7 is a flow diagram illustrative of a short form declaration generation routine implemented by a port agent processing system in accordance with the present invention;

FIG. 8 is a block diagram illustrative of screen display generated by a port agent processing system for generating short form declarations in accordance with the present invention;

FIG. 9 is a flow diagram illustrative of a supplemental declaration routine implemented by a central document processing system in accordance with the present invention; and

FIG. 10 is a block diagram illustrative of a screen display generated by a central document processing system for generating supplemental declarations in accordance with the present invention.

### DETAILED DESCRIPTION OF THE PREFERRED EMBODIMENT

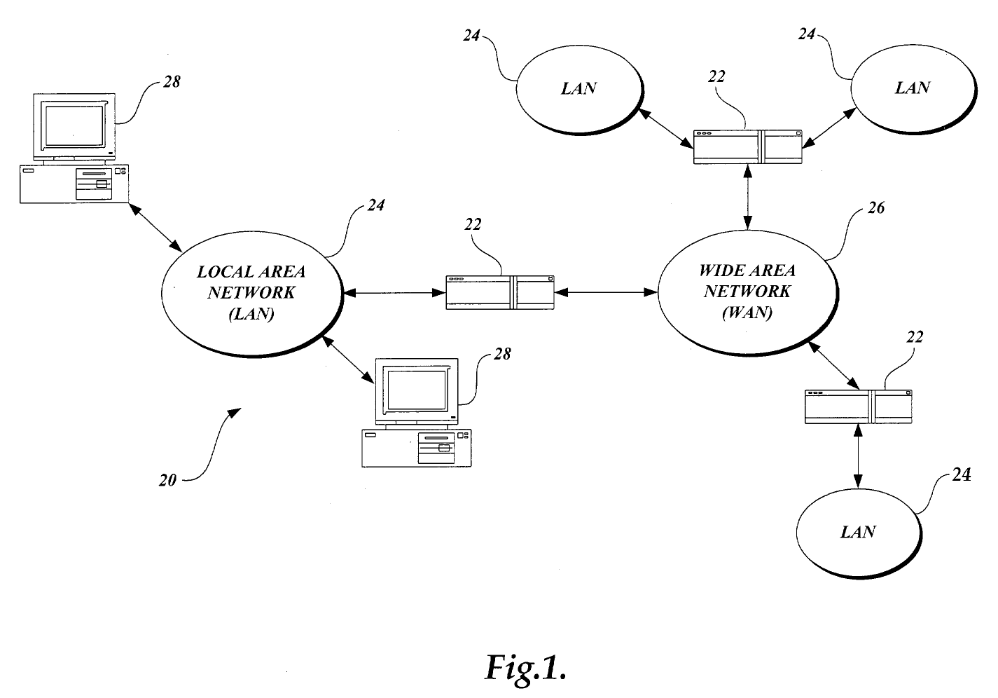

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Imbedded within a hypertext document are a number of hyperlinks, i.e., highlighted portions of text which link the document to another hypertext document possibly stored at a Web site elsewhere on the Internet. Alternatively, the hyperlinks may include one or more parameters that are passed to an application that dynamically generates a requested document. Each hyperlink is assigned a Uniform Resource Locator (“URL”) that provides the exact location of the linked document on a server, or the generating application, connected to the Internet and describes the document. Thus, whenever a hypertext document is retrieved, or generated, from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a graphical user interface to the WWW. Upon request from the remote access user via the web browser, the web browser locates and retrieves the desired hypertext document from the appropriate web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the web server, such as JAVA applets, for execution on the client computer.

The present application is directed toward a system and method for facilitating the processing of multi-part documentation utilized to complete transactions. More specifically, the present invention is directed toward a system and method for managing the generation of importation declarations by a number of local port agents and a central document processing system. The management of the import declarations is facilitated through the use of a unique declaration identifier identifying a particular important transaction. In an illustrative embodiment of the present invention, the unique identifier is a consignment reference number. Although the present invention will be described in regards to an implementation with an illustrative document processing system, one skilled in the relevant art will appreciate that the disclosed document processing system and the disclosed embodiments are illustrative in nature and should not be construed as limiting.

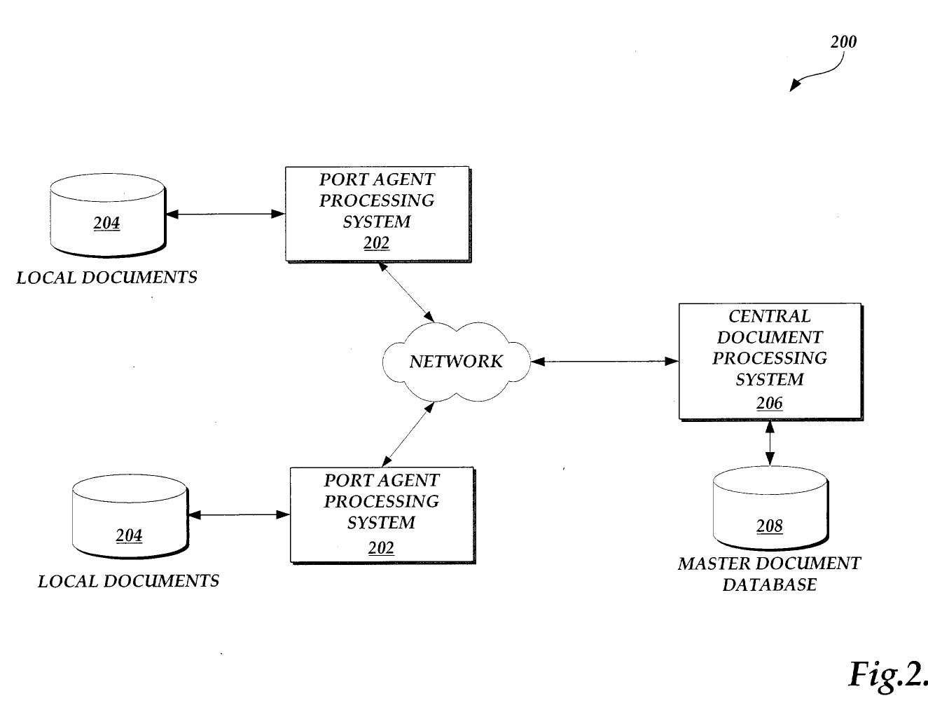

Referring now to FIG. 2, an interactive document processing system 200 for generating import declarations supplied to government officials will be described. In an illustrative embodiment of the present invention, the document processing system 200 can be a private, subscriber-based system allowing a number of parties to interact via a common communication network, such as the Internet 20. Alternatively, the document processing system 200 can be a public system allowing access to any number of parties via the communication network. Still further, the document processing system 200 can also incorporate a combination of private and public communication networks.

As illustrated in FIG. 2, the document processing system 200 includes a number of port agent processing systems 202 associated with one or more port agents utilizing the document processing system. Each port agent 202 can include a repository 204 for holding electronic documents utilized in clearing incoming shipments through customs. Although a limited number of importer computing devices 202 are shown in FIG. 2, the document processing system 200 can include any number of port agent processing systems 202. In an illustrative embodiment of the present invention, each port agent processing system 202 can correspond to a port agent that obtains custom clearance for goods being imported by a particular client. Accordingly, the port agent processing systems 202 do not necessarily correspond to the same entity and may be comprised of any number of individual port agents or one or more collections of port agents. Each port agent processing system can correspond to any number of computing devices, such as personal computers, hand-held computers, server computers, personal digital assistants, mobile computing devices, mobile telephones, and any combination thereof.

The document processing system 200 also includes a centralized document processing system 206 in communication, directly or indirectly, with the port agent processing systems 202. The centralized document processing system 206 serves as a centralized data warehouse for managing incoming declaration data from each port agent processing system 202 and for generating supplemental declaration materials for each transaction. The centralized document processing system 206 can include a master document repository 208 for maintaining incoming declaration data and for maintaining supplemental declaration data. Further, the centralized document processing system 206 can include a separate, or independent, component for generating the supplemental declaration documentation.

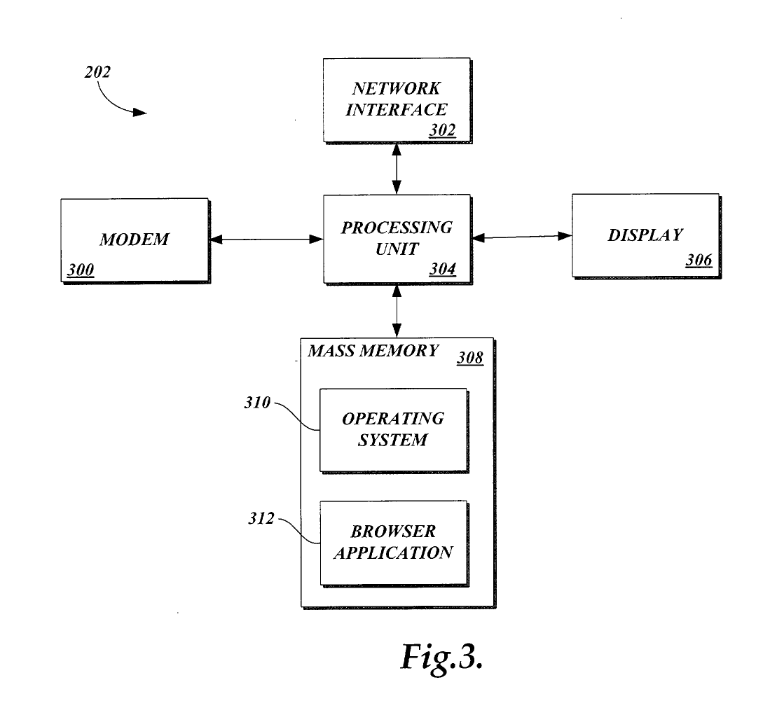

FIG. 3 depicts several of the key components a port agent processing system 202 (FIG. 2). Those of ordinary skill in the art will appreciate that the computing devices can include many more components than those shown in FIG. 3. However, it is not necessary that all of these generally conventional components be shown in order to disclose an illustrative embodiment for practicing the present invention.

As shown in FIG. 3, each computing device may include a modem 300 for connecting to an Internet service provider through a Point-to-Point Protocol (“PPP”) connection or a Serial Line Internet Protocol (“SLIP”) connection as known to those skilled in the art. The modem 300 may utilize a telephone link, cable link, wireless link, Digital Subscriber Line or other types of communication links known in the art. The computing devices may also include a network interface 302 for connecting directly to a LAN or a WAN, or for connecting remotely to a LAN or WAN. Those of ordinary skill in the art will appreciate that the network interface 302 includes the necessary circuitry for such a connection, and is also constructed for use with various communication protocols, such as the TCP/IP protocol, the Internet Inter-ORB Protocol (“IIOP”), and the like. The network interface 302 may utilize the communication protocol of the particular network configuration of the LAN or WAN it is connecting to, and a particular type of coupling medium.

The computing devices also include a processing unit 304, a display 306, and a memory 308. The memory 308 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 308 stores an operating system 310 for controlling the operation of the port agent computing device 202. The memory 308 also includes an access application communication application for accessing the document processing system 200 via the communication network. Examples of an access application can include a WWW browser 312, such as Netscape's NAVIGATOR® or Microsoft's INTERNET EXPLORER® browsers. One skilled in the relevant art will appreciate that these components may be stored on a computer-readable medium and loaded into memory 308 of the importer computing device 202 using a drive mechanism associated with the computer-readable medium, such as a floppy, CD-ROM, DVD-ROM drive, or network interface 302. The memory 308, display 306, modem 300 and network interface 302 are all connected to the processor 304 via a bus. Other peripherals may also be connected to the processor in a similar manner.

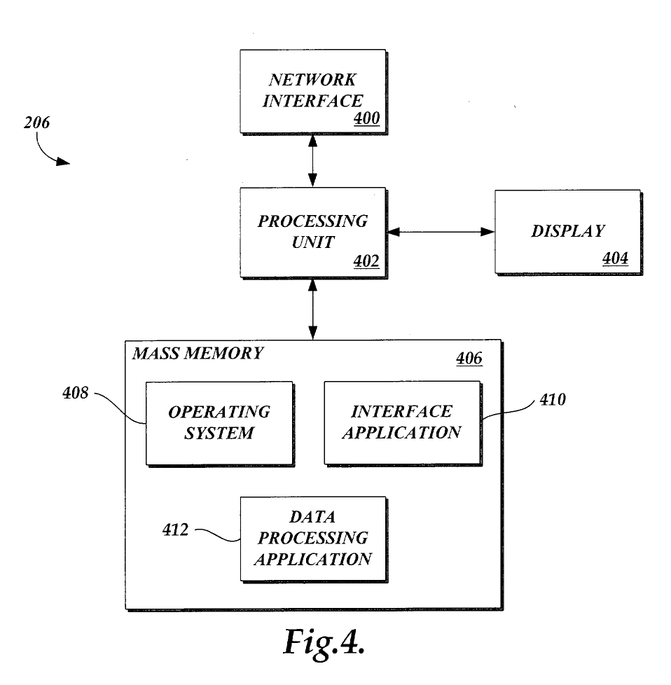

FIG. 4 is a block diagram depicting an illustrative architecture of a centralized document processing system 206 (FIG. 2) in accordance with the present invention. As shown in FIG. 4, the centralized document processing system 206 is connected to the communication network via a network interface 400. Those of ordinary skill in the art will appreciate that the network interface 400 includes the necessary circuitry for connecting the centralized document processing system 206 to the Internet 20, and is constructed for use with the TCP/IP protocol, or other protocols, such as IIOP. The central document processing system 206 also includes a processing unit 402, a display 404 and a mass memory 406, all connected via a communication bus, or other communication device. The mass memory 406 generally comprises a RAM, ROM, and a permanent mass storage device, such as a hard disk drive, tape drive, optical drive, floppy disk drive, or combination thereof. The mass memory 406 stores an operating system 408 for controlling the operation of the referral processing system. It will be appreciated that this component may comprise a general-purpose server operating system as is known to those skilled in the art, such as UNIX, LINUX™, or Microsoft WINDOWS NT®.

The mass memory 406 also stores program code and data for interfacing with one or more components of the document processing system 200 and for identifying and resolving documentation discrepancies. More specifically, the mass memory 406 stores a port agent interface application 410 in accordance with the present invention for communicating with the port agent processing systems 202. The mass memory 406 further stores a data processing 412 for processing incoming declaration data from the port agent processing systems 202, for generating unique declaration identifiers for each shipping transaction, and for generating supplemental declaration data based on a processing of the incoming declaration data. One skilled in the relevant art will appreciate that the various components may be stored on a computer-readable medium and loaded into the memory 406 using a drive mechanism associated with the computer-readable medium, such as a floppy, CD-ROM, DVD-ROM drive, or network interface 400.

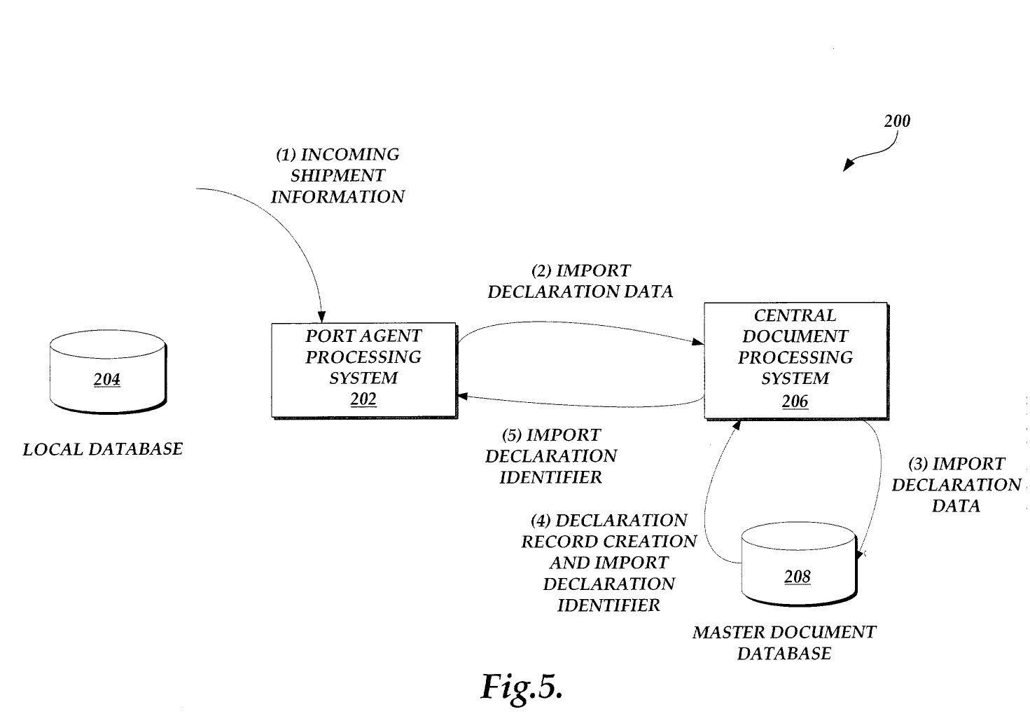

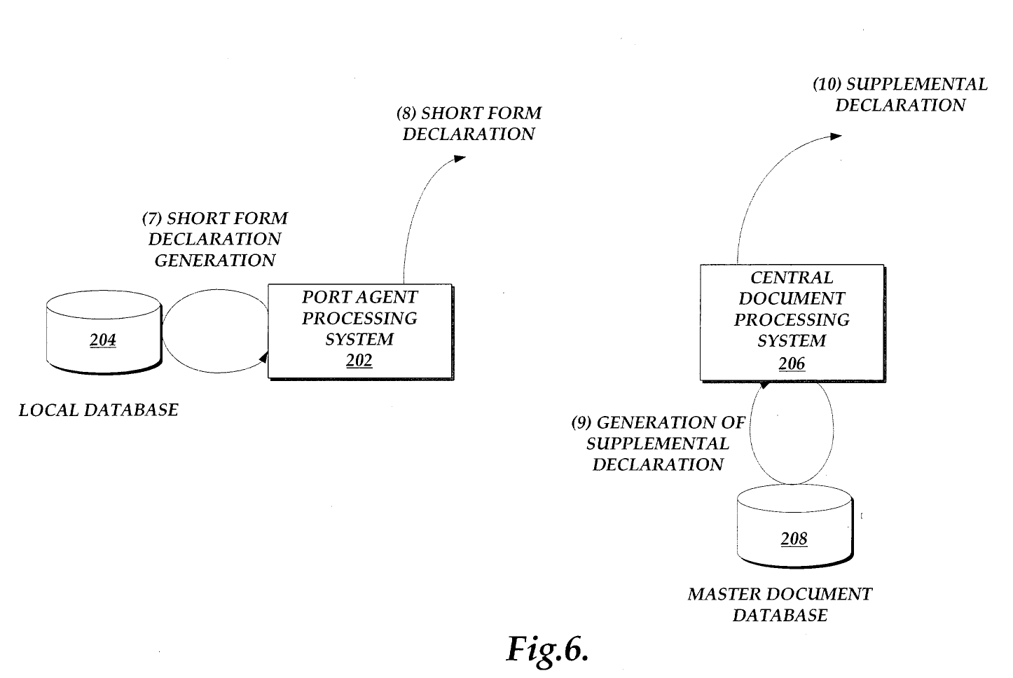

Referring now to FIGS. 5 and 6, a general overview of the document processing system 200 and the interaction between the various components of the document processing system will be described. With reference to FIG. 5, a port agent processing system 202 typically contracts with an importing company to processing incoming good shipments to a particular port of entry for the company. The incoming shipment information may be based upon electronic documentation provided by a carrier/importer and/or via physical documentation accompanying the shipment. The port agent processing system 202 transmits the incoming shipment document via a communication to the central document processing system 206. In an illustrative embodiment of the present invention, the transmission of the incoming shipment information is facilitated through a Web-based interface generated at the port agent processing system 202. Based upon the information provided by each port agent processing system, the central document processing system 206 generates a record for a shipment declaration and associates a unique declaration identifier for the shipment declaration record. The unique declaration identifier is transmitted to the appropriate port agent processing system 202.

With reference now to FIG. 6, after receiving the unique declaration identifier, the port agent processing system 202 generates a short form declaration. In an illustrative embodiment of the present invention, the short form declaration includes all of the information necessary to allow the incoming shipment to be released to the importing company. Accordingly, government agencies and/or the importing company may specify, at least in part, the data to be included in the short form declaration. Subsequent to the generation of the short form document by the port agent processing system 202, the central document processing system 206 obtains any additional data necessary to complete a shipment declaration and generates a supplemental declaration based on the same unique declaration identifier. Similar to the short form declaration, the data included in the supplemental declaration may be specified, in part, by government agencies and/or the importing company. The central document processing system 206 transmits the supplemental declaration to the appropriate party.

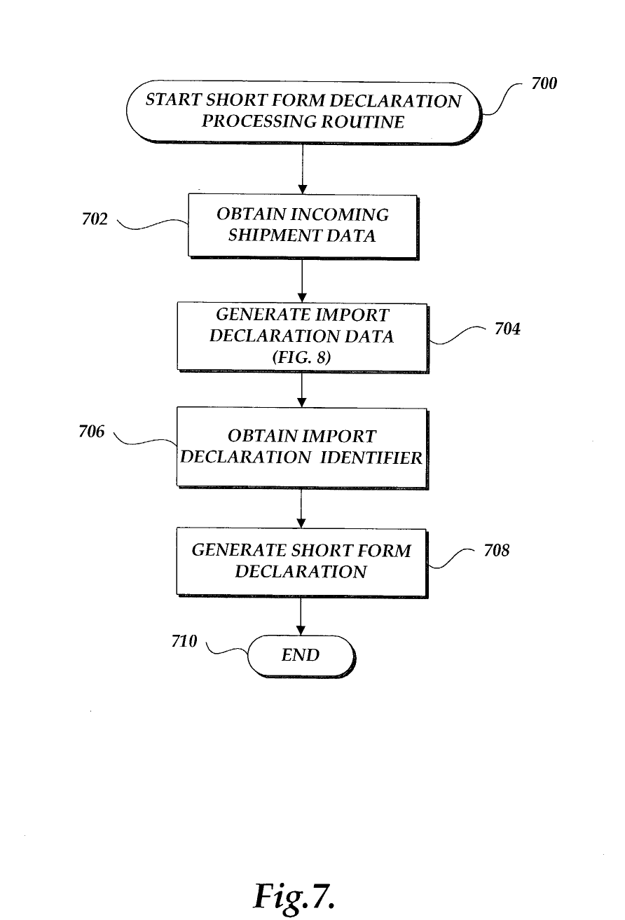

With reference now to FIG. 7, a short form declaration processing routine 700 implemented by a port agent processing system 202 will be described. At block 702, the port agent processing system 202 obtains incoming shipment data. As described above, the incoming shipment data may be obtained via electronic transmission by an appropriate party or via physical transmission with the incoming goods. At block 704, the port agent processing system 202 generates incoming shipment information. In an illustrative embodiment of the present invention, an agent associated the port agent processing system manipulates a screen interface provided to create a shipment declaration record for storing incoming shipment data and to generate a short form declaration to be utilized by the port agent processing system to release the incoming goods from customs. The shipment data supplied in the screen interface is transmitted to the central document processing system 206.

At block 706, the port agent processing system 202 obtains a shipment declaration record identifier from the central document processing system 206 that is associated with the data previously submitted by the port agent processing system. The import declaration record identifier can be a unique identifier that is correlated to a single incoming shipment. To generate a unique identifier, the central document processing system 206 can utilize information such as date (e.g., year), country codes for country of export/import (e.g., ISO Alpha-2 representations, importer identifier (e.g., abbreviated identifier), internal identifiers, validation information and the like. Utilizing the shipment declaration identifier, at block 708, the port agent processing system 202 generates a short form declaration to be utilized to clear the incoming shipment through customs. At block 710, the routine 700 terminates.

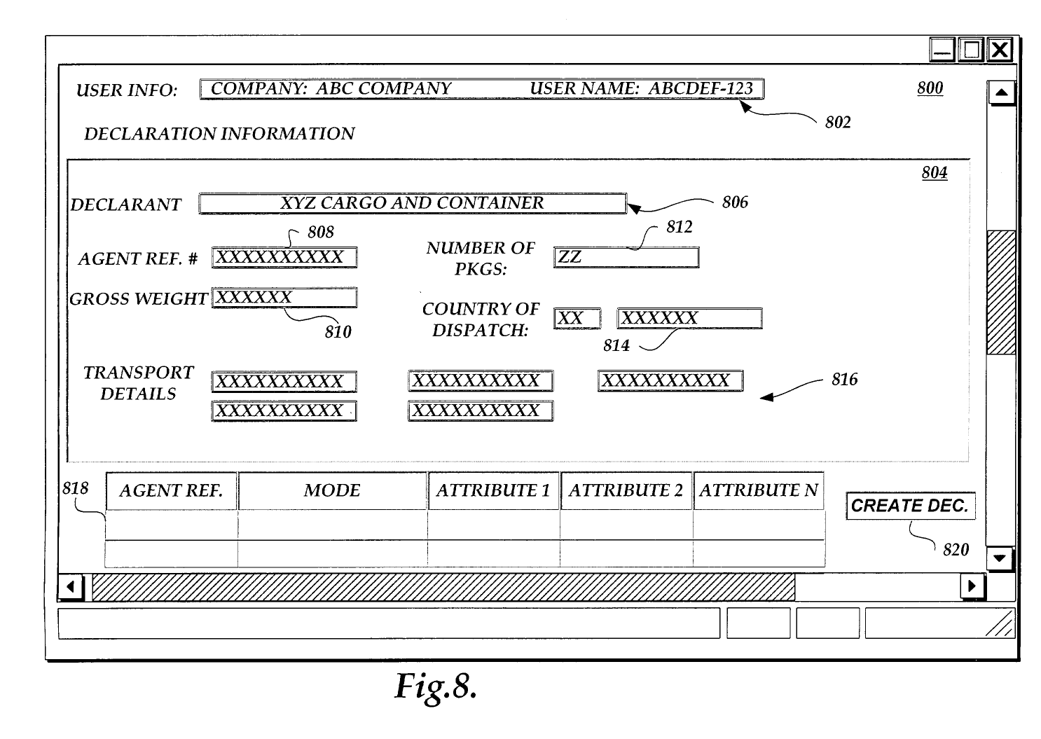

FIG. 8 is a block diagram illustrative of a screen display 800 generated by the port agent processing system 202 to transmit shipment information to the central document processing system 206 in accordance with the present invention. The screen interface 800 includes an agent identification portion 802 for specifying which port agent is processing the incoming shipment. The screen interface 800 also includes a declarant information portion 804 for specifying particular information about the incoming shipment. The declarant information portion 804 includes a declaration identification portion 804 for specifying the declarant for the incoming goods and an agent reference portion 808 for tracking shipments for the port agent. The declarant information portion 804 also includes information for specifying the gross weight 810 of the incoming shipment, the number of packages 812 included in the shipment and the country of dispatch 814. The declarant information portion 804 further includes transportation details portion 816 for specifying details regarding the incoming shipment. The transportation details portion 816 can include fields for specifying a mode of transportation, a master ocean bill, a vehicle trailer number, a con note number, a Master Air Waybill, a House Air Waybill, a Master Ocean Bill of Lading, a House Ocean Bill of Lading, and/or a truck reference number.

The screen display 800 also includes a shipment tracking portion 818 that allows multiple shipments to be processed at the same time. In an illustrative embodiment of the present invention, each shipment will be associated with a unique identifier. The shipment tracking portion 818 can include a number of fields for tracking shipments, including agent reference numbers, modes of transportation, and any other attributes such as weight, origination and the like. The screen interface 800 also includes a control 820 for transmitting the shipment data to the central document processing system 206 and obtaining an important declaration identifier. Although the screen interface 800 is described with specific reference fields, one skilled in the relevant art will appreciate that the screen display 800 may include any number of additional or alternative fields in accordance with the present invention.

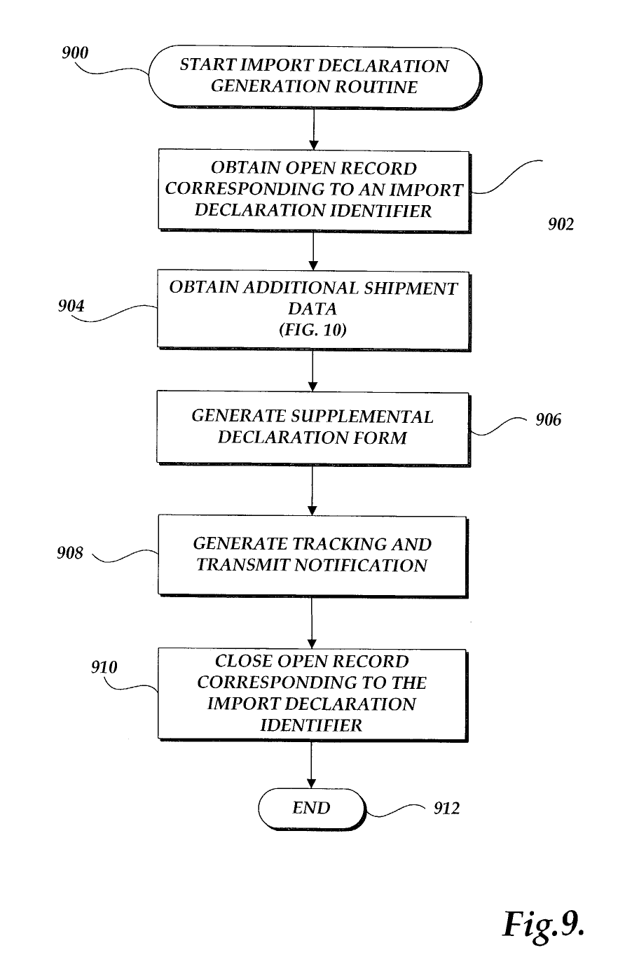

With reference now to FIG. 9, a routine 900 implemented by the central document processing system 206 to generate a supplemental declaration will be described. At block 902, the central processing system 206 obtains an open import declaration identifier to complete. As described above, the central processing system 206 generates import declaration identifiers at the request of a port agent processing system 202. After returning the import declaration identifier to allow the port agent to generate a short form declaration, an agent at the central processing system 206 edits an open record corresponding to the import declaration identifier to generate a supplemental declaration. In an illustrative embodiment of the present invention, the agent may utilize various searching tools to display open records to be processed. The listing may be presented in a table format to the agent via a user interface.

At block 904, the central processing system 206 obtains additional shipment data and enters the data into the record. In an illustrative embodiment of the present invention, an agent at the central processing system 206 may utilize a screen interface to enter the additional shipment data. At block 906, the central processing system 206 generates a supplemental declaration corresponding to the import declaration identifier. At block 908, the central processing system 206 generates tracking information and transmits notification of the complete declaration. Having completed the process, at block 910, the central processing system 206 closes the open record and the routine 900 terminates at block 912. The supplemental declaration form may be filed with the appropriate government agency to complete the requirements required for incoming goods.

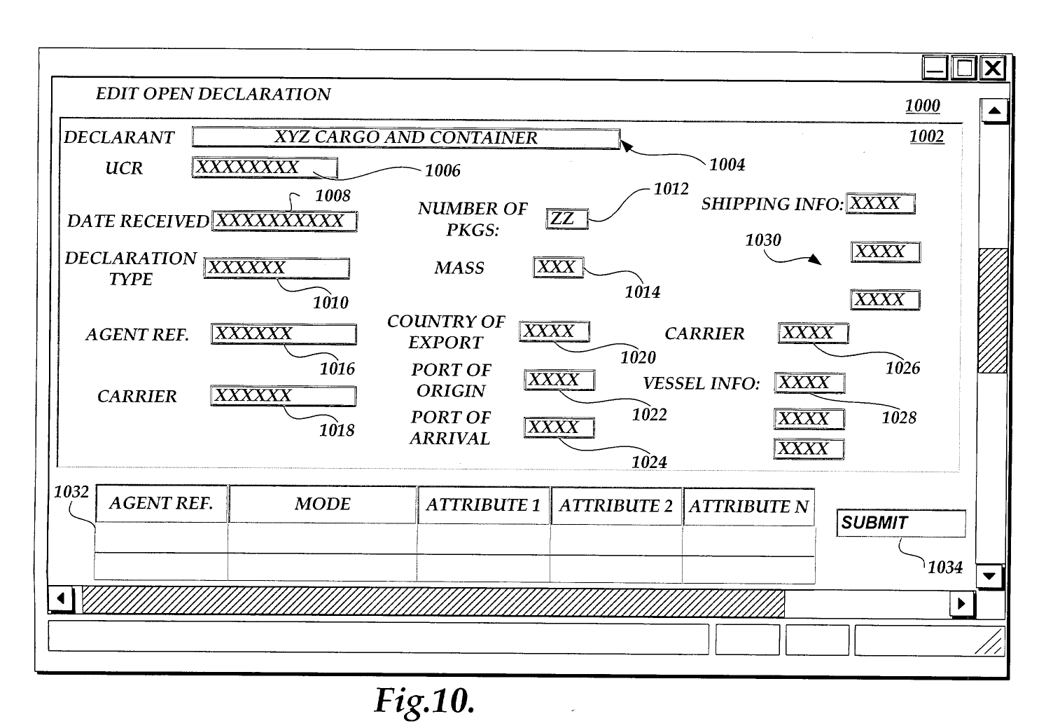

FIG. 10 is a block diagram illustrative of a screen display 1000 generated by the central processing system 206 to generate supplemental declarations in accordance with the present invention. The screen display 1000 includes an editing portion 1002 for entering additional shipment information. The editing portion 1002 includes a declarant identification field 1004 and an import declaration identifier field 1004 for specifying which record to open. The editing portion 1002 further includes additional fields for specifying aspects of the shipping information not provided by the port agent processing system 202. The fields include a date field 1008 for specifying a date in which the goods were received, a declaration type field 1010 for selecting between various types of declarations (if possible), and a carrier identification field for identifying a particular carrier. The fields can also include a number of packages field 1012 for specifying the number of packages in the incoming shipment and the mass field 1014 for specifying the mass of the incoming shipment. The fields can further include transportation fields including a country of import 1020, a port of origin 1022, and a port of arrival 1024. The fields can include vessel information 1026 for specifying vessel names, identification numbers, dates of travel, dates of arrival and location of goods.

The screen display 1000 can include a shipping information portion 1028 for tracking various shipping information including master bill, house bill, trailer number, truck number, and other shipping information. In an illustrative embodiment of the present invention, at least some of the shipment information may be populated by the central document processing system 206 based on information previously entered by the port agent processing system 202. The screen display 1000 also includes a shipment tracking portion 1030 for selecting one or more incoming shipments to associate with the declaration. The shipment tracking portion 1030 can include a number of fields for tracking shipments, including agent reference numbers, modes of transportation, and any other attributes such as weight, origination and the like. Additionally, the shipment tracking portion 1030 can include a control 1032 for submitting the additional information and generating a supplemental declaration in accordance with the present invention.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a system including at least one port agent processing system and a centralized document processing system, a method for processing transaction documentation, the method comprising:
obtaining incoming shipment information corresponding to a shipment of goods to be imported;
generating a declaration identifier request, the request including a specification of a subset of the incoming shipment information;
obtaining a declaration identifier corresponding to the shipment of goods; and
generating a declaration document corresponding to the subset of the incoming shipment information and the declaration identifier.

2. The method as recited in claim 1, wherein obtaining incoming shipment information includes obtaining an electronic document including the shipment information.

3. The method as recited in claim 1, wherein generating a declaration identifier request includes:
generating a screen display including one or more fields corresponding to the incoming shipment information;
obtaining user input from an interface device, the user input corresponding to the one or more fields of the screen display; and
transmitting the user input to request a declaration identifier.

4. The method as recited in claim 1, wherein the declaration identifier is a unique identifier.

5. The method as recited in claim 4, wherein the declaration identifier includes information selected from a group consisting of a current year, a country designation of a country of export, a representation of a supplier of the shipment, and an internal reference number.

6. The method as recited in claim 1, wherein the first document is a short form declaration filed with a government agency.

7. A computer-readable medium having computer-executable instructions for performing the method recited in claim 1.

8. In a system including at least one port agent component and a centralized document processing component, a method for processing transaction documentation, the method comprising:
obtaining, by a port agent component, incoming shipment information corresponding to a shipment of goods to be imported;
generating, by the port agent component, a declaration identifier request, the request including a specification of a subset of the incoming shipment information;
obtaining, by a centralized document processing component, the declaration identifier request from the port agent component;
generating, by the centralized document processing component, a declaration identifier corresponding to the shipment of goods;
obtaining, by the port agent component, the declaration identifier corresponding to the shipment of goods;
generating, by the port agent component, a first declaration document corresponding to the subset of the incoming shipment information and the declaration identifier; and
generating, by the centralized document processing component, a second declaration document corresponding to at least a subset of the incoming shipment information and the declaration identifier, wherein the first and second declaration generate a complete declaration for the incoming shipment of goods.

9. The method as recited in claim 8, wherein obtaining incoming shipment information includes obtaining an electronic document including the shipment information.

10. The method as recited in claim 8, wherein generating a declaration identifier request includes:
generating a screen display including one or more fields corresponding to the incoming shipment information;
obtaining user input from an interface device, the user input corresponding to the one or more fields of the screen display; and
transmitting the user input to request a declaration identifier.

11. The method as recited in claim 8, wherein the declaration identifier is a unique identifier.

12. The method as recited in claim 11, wherein the declaration identifier includes information selected from a group consisting of a current year, a country designation of a country of export, a representation of a supplier of the shipment, and an internal reference number.

13. The method as recited in claim 8, wherein the first document is a short form declaration filed with a government agency.

14. A computer-readable medium having computer-executable instructions operable to perform the method recited in claim 8.

15. A system for processing transaction documentation, the system comprising:
at least one port agent processing system, the port agent processing system for obtaining incoming shipment information corresponding to a shipment of goods and for generating a request for a declaration identifier corresponding to the shipment of goods; and
a centralized document processing computing device, the centralized document processing computing device for processing the request for the declaration identifier from the at least one port agent processing system;
wherein the port agent processing system generates a first declaration document corresponding to a subset of the incoming shipment information and the declaration identifier;
wherein the centralized document processing system generates a second declaration document corresponding to at least a subset of the incoming shipment information and the declaration identifier; and
wherein the first and second document include different subsets of the incoming shipment information.

16. The system as recited in claim 15, wherein the port agent processing system generates a screen display including a number of fields for obtaining the subset of the incoming shipment information.

17. The system as recited in claim 15, wherein the centralized document processing system generates a screen display including a number of fields for obtaining the subset of the incoming shipment information.

18. The system as recited in claim 15, wherein the declaration identifier is a unique identifier.

19. The method as recited in claim 18, wherein the declaration identifier includes information selected from a group consisting of a current year, a country designation of a country of export, a representation of a supplier of the shipment, and an internal reference number.
